(19) United States
(12) Patent Application Publication
(10) Pub. No.: US 2004/0081032 A1
(43) Pub. Date: Apr. 29, 2004

(54) Annealed magnetic domain wall displacement type magneto-optical recording medium

(76) Inventor: Koichiro Nishikawa, Gunma (JP)

Correspondence Address: FITZPATRICK CELLA HARPER & SCINTO, 30 ROCKEFELLER PLAZA, NEW YORK, NY, 10112, US

(21) Appl. No.: 10/683,430

(22) Filed: Oct. 14, 2003

(30) Foreign Application Priority Data
Oct. 21, 2002 (JP) 2002-305736

(51) Int. Cl. G11B 11/00

(52) U.S. Cl. 369/13.47

(57) ABSTRACT

Two-dimensionally annular or spiral lands and grooves are formed in a magneto-optical disk having a magnetic layer composed of a magnetic domain wall displacement layer, a switching layer, and a record retaining layer. The lands and the grooves are each used as a recording and reproducing area. A side wall present between the land and the groove and its vicinity are annealed so as to change the physical properties of these areas. The width of the land is larger than the width of the groove by 0.5 to 4 times the width of the side wall. Further, the ratio of the width of the land to the width of the groove is 1.05 to 1.20. Furthermore, the grooves have a period of 1.0 to 1.2 microns.

### BACKGROUND OF THE INVENTION

1. Field of the Invention

The present invention relates to a magneto-optical recording medium in which information is recorded in a magnetic thin film (magnetic layer) and in particular, to a magneto-optical recording medium from which recorded information is reproduced using a magnetic domain wall displacement reproducing method.

2. Related Background Art

A rewritable high-density recording method for a magneto-optical recording medium uses thermal energy from a semiconductor laser to write a magnetic domain (recording mark) in a magnetic thin film (magnetic layer) to record information and uses a magneto-optical effect to read information. In recent years, there have been more and more demands to increase further the recording density of magneto-optical media based on the above method to achieve recording media of an increased capacity. The linear density of recording of an optical disc that is a magneto-optical recording medium such as the one described above depends markedly on a laser wavelength of reproducing optical system and a numerical aperture of an objective lens. However, there is a limit to the improvement of the laser wavelength of a reproducing optical system or the numerical aperture of an objective lens. Thus, techniques have been developed which increase the recording density by improving the configuration of the magneto-optical recording medium or a recording method.

For example, Japanese Patent Application Laid-Open No. 06-290496 (first conventional example) discloses such a technique. According to this technique, in the magnetic layer of a multilayer film structure having a magnetic domain wall displacement layer and a recording retaining layer which are magnetically coupled together, information is recorded in the recording retaining layer. When information is reproduced, the magnetic domain wall of a recording mark transferred to the magnetic domain wall displacement layer is displaced utilizing a temperature gradient obtained by irradiations with light beams and without changing the information recorded in the recording retaining layer. Then, by magnetizing the magnetic domain wall displacement layer so as to set a part of the area of a light beam spot in the same magnetization state and detecting a change in the plane of polarization of a reflected light beam, the recording mark can be reproduced even under the resolution of a light beam spot. This method enables the recording mark to be reproduced even under the resolution of a light beam spot. It is thus possible to achieve a magneto-optical recording medium with a sharply increased recording density and transfer speed as well as a reproduction method for this magneto-optical recording medium.

In this magneto-optical recording medium, in order to allow the magnetic domain wall as a recording mark to be easily displaced in the magnetic domain wall displacement layer utilizing the temperature gradient obtained by irradiations with light beams, annealing is executed in which adjacent grooves across each track (land) that is an area where information is recorded and reproduced are irradiated with high-power laser beams to change the recording retaining layer in the groove portions. This annealing prevents the magnetic domain wall forming a recording mark from becoming a closed magnetic domain, i.e. allows adjacent tracks to be magnetically separated from each other. This annealing serves to provide appropriate reproduced signals.

Further, magneto-optical disks have been enthusiastically studied which enable not only lands but also grooves to be used as tracks, i.e., information recording and reproducing areas, in order to increase the density. This method is generally called “land and groove system”.

For example, the invention described in Japanese Patent Application Laid-Open No. 11-195252 (second conventional example) realizes a magneto-optical recording medium used for the land and groove system and having deep grooves, by controlling the surface roughness of a slope-shaped side wall (in Japanese Patent Application Laid-Open No. 11-195252, this is represented as an inclined surface of a land portion) corresponding to the boundary between the land and the groove in a substrate. Experiments indicate that this method enables data to be recorded or reproduced at a linear density of recording of 0.11 μm/bit using the land and groove recording medium having deep grooves of the track pitch 0.6 μm (depth: about 100 nm).

With the method of annealing the grooves according to the above first conventional example, the grooves cannot be utilized as recording and reproducing areas. There is a problem that it is thus difficult to reduce the track pitch.

Further, if an attempt is made to execute a magnetic domain wall displacement type recording and reproducing method in the land and groove system as described in the second conventional example, in order to reliably separate the tracks from one another using steps or the like, it is necessary to form relatively deep grooves, i.e. grooves having a depth of about 100 nm or more. Thus, the behavior of incident light in a near field, i.e. the behavior of electromagnetic waves in the vicinity of an arbitrary boundary (a sufficiently small area compared to the wavelength) makes a temperature distribution formed while a land is being traced significantly different from a temperature distribution formed while a deep groove is being traced. In particular, a higher light intensity is required to record data in a land compared with the time of tracing a deep groove. Accordingly, if land recording is carried out under optimum conditions, there is a problem that cross writes may occur in the grooves. On the other hand, if the grooves are formed to be shallow, there is a problem that it may be difficult to effectively separate magnetically the tracks from one another.

### SUMMARY OF THE INVENTION

An object of the present invention is to provide a magnetic domain wall displacement type magneto-optical recording medium which enables magnetic domain wall displacement reproduction using the land and groove system and which reduces the difference in performance between lands and grooves formed with a small track pitch.

Another object of the present invention is to provide a magnetic domain wall displacement type magneto-optical recording medium comprising:

a substrate in which a land and a groove are formed; and

a magnetic layer formed on the substrate;

wherein the magnetic layer on a side wall present between the land and the groove, and in a vicinity of the side wall is annealed, side wall and the width of the land is larger than the width of the groove.

### BRIEF DESCRIPTION OF THE DRAWINGS

FIG. 1 is a schematic sectional view showing essential parts of a magneto-optical disk according to the present invention;

FIG. 2 is a schematic view of an annealing apparatus used for a method of manufacturing a magneto-optical disk according to the present invention;

FIG. 3 is a schematic plan showing a step of irradiating a magneto-optical disk with light in the method of manufacturing a magneto-optical disk according to the present invention;

FIG. 4 is a diagram illustrating the structure of a grating in the annealing apparatus shown in FIG. 2;

FIG. 5 is a block diagram schematically showing a tracking error generating circuit in the annealing apparatus shown in FIG. 2;

FIG. 6 is a graph illustrating a tracking error in the method of manufacturing a magneto-optical disk according to the present invention;

FIG. 7 is a graph showing a heat generation distribution in a radial direction observed during the step of irradiating the magneto-optical disk with light in the method of manufacturing a magneto-optical disk according to the present invention;

FIG. 8 is a diagram showing intensity contour lines observed during the step of irradiating the magneto-optical disk with light in the method of manufacturing a magneto-optical disk according to the present invention;

FIG. 9 is a graph showing a temperature distribution in the radial direction observed during the step of irradiating the magneto-optical disk with light in the method of manufacturing a magneto-optical disk according to the present invention;

FIG. 10 is a diagram showing isotherms observed during the step of irradiating the magneto-optical disk with light in the method of manufacturing a magneto-optical disk according to the present invention; and

FIG. 11 is a schematic plan showing essential parts of a magneto-optical disk according to the present invention.

### DESCRIPTION OF THE PREFERRED EMBODIMENTS

An embodiment of the present invention will be specifically described below with reference to the drawings. The embodiment illustrated below is an example of the best mode of the present invention. However, the present invention is not limited by these embodiments.

(Magneto-Optical Medium)

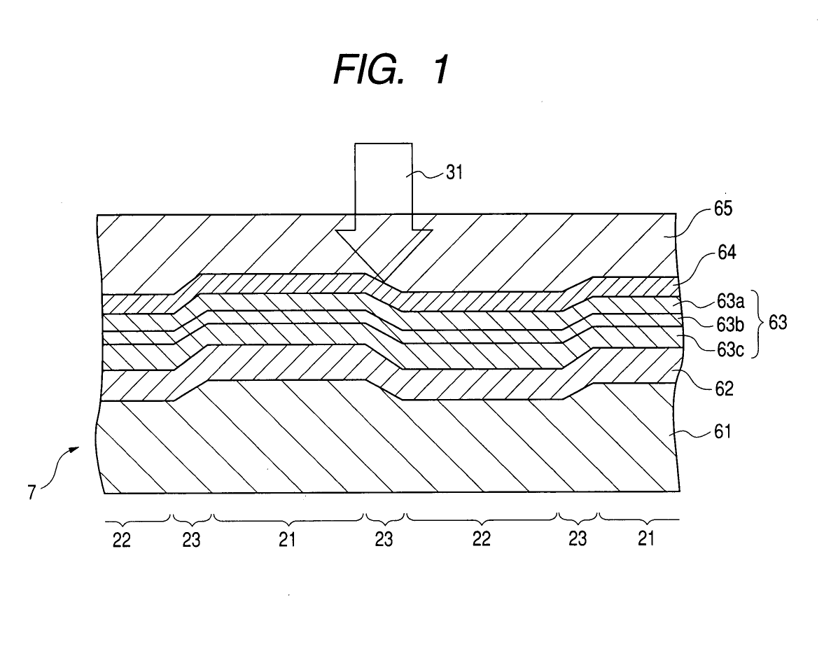

First, with reference to FIG. 1, description will be given of a magneto-optical recording medium (magneto-optical disk) 7 according to the present embodiment. The magneto-optical disk 7 is composed of a substrate 61, and a lower layer 62, a magnetic layer 63, an upper layer 64, and a protective layer 65 sequentially stacked on the substrate 61. The magnetic layer 63 includes at least a magnetic domain wall displacement layer 63a, a switching layer 63b, and a record retaining layer 63c. The magneto-optical disk 7 is configured on which lands 21 as convex portions and grooves 22 as concave groove portions are alternately arranged in such a manner that a side wall 23 having concentric or spiral shape as seen in a plan view is sandwiched between the land 21 and the groove 22. The side wall 23 is irradiated with annealing beam (main beam) 31, as schematically shown in FIG. 1, and thus annealed to have its physical properties changed. Most of the lands 21 and the grooves 22 are not affected by the annealing and can thus used as recording and reproducing areas.

Specifically, the depth of the groove 22 is 60 nm, and the side wall 23 has an inclination of 45°. The width of the land 21 (half-value width) is 0.58 micron, and the width of the groove 22 (half-value width) is 0.50 micron. The ratio of the width (half-value width) of the land 21 to the width (half-value width) of the groove 22 is about 1.16 to 1. The track (recording and reproducing area) except for an annealed area has a width of about 0.44 micron. Each of the land 21 and the groove 22 has almost the same value as this value. That is, the magneto-optical disk 7 is a small-track-pitch magnetic domain wall displacement type magneto-optical recording medium having a track width of 0.44 micron and a track pitch of 0.54 micron. Experiments indicate that a track width of about 0.40 micron serves to reduce a bit error rate down to 1×10⁻⁴ or less when data is recorded and reproduced using 1-7RLL modulation and a value of 0.08 μm/bit. Equivalent performance can be achieved even with a track width of 0.44 micron.

As described above, the present embodiment provides the magneto-optical disk 7, in which the groove 22 has a depth of 60 nm and is shallower than those in the prior art and in which the track pitch is small. Further, in the magneto-optical disk 7, the side wall 23, having its physical properties changed by annealing, magnetically separates the tracks from each other. Furthermore, the magneto-optical disk 7 enables magnetic domain wall displacement type reproduction by the land and groove system.

The dimensions of the magneto-optical disk 7 according to the present invention are not limited to the above example. However, the groove 22 is formed to have a depth of about 10 to 80 nm, and the side wall 23 is formed to have an inclination of 15° to 75°. More preferably, the groove 22 is formed to have a depth of about 20 to 60 nm, and the side wall 23 is formed to have an inclination of 30° to 60°. The reason will be described in connection with a method of manufacturing a magneto-optical recording medium, described later.

(Method of Manufacturing Magneto-Optical Recording Medium)

Now, detailed description will be given as to a method of manufacturing a magneto-optical recording medium according to the present invention in order to manufacture the above-described magneto-optical disk 7.

First, as shown in FIG. 1, the following layers are sequentially stacked on a substrate 61; a lower layer 62; a magnetic layer 63 composed of three layer structure including a magnetic domain wall displacement layer 63a, a switching layer 63b, and a recording retaining layer 63c; an upper layer 64; and a protective layer 65. The lands 21 as convex portions and the grooves 22 as concave groove portions are alternately arranged in such a manner that the side wall 23 having a concentric or spiral shape in a plan view is sandwiched between the land 21 and the groove 22. This formation method is not described here in detail but a conventional well-known one may be used. Then, the side walls 23 are annealed. A detailed description will be given later as to a method of designing the dimensions of the land 21, groove 22, and side wall 23 which is used in the above formation step.

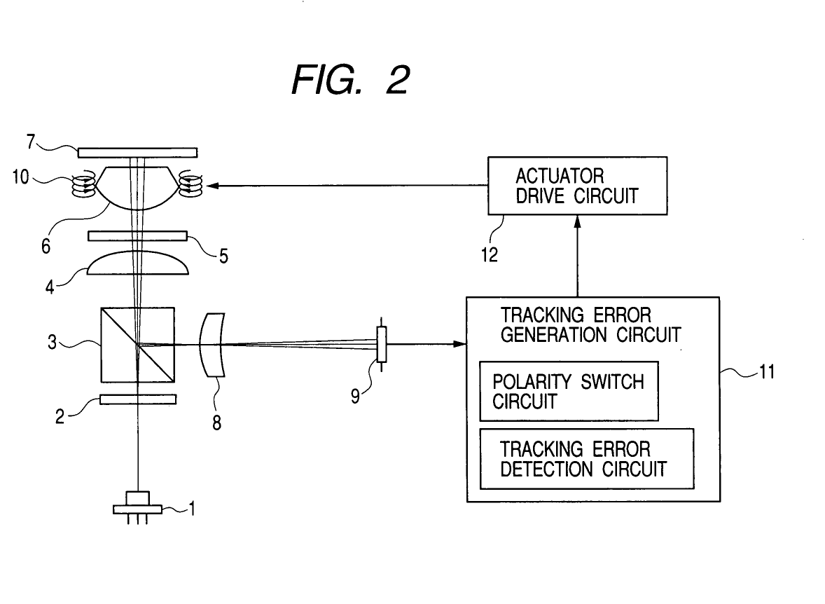

A specific description will be given as to the annealing executed on the side wall 23. FIG. 2 schematically shows an annealing apparatus used in the present embodiment. The annealing apparatus has a semiconductor laser 1 as a light source for annealing; a grating 2, a polarization beam splitter (PBS) 3, a collimator 4, ¼ wavelength plate 5, an objective lens 6, and disc holding means (not shown) arranged in a line on the optical axis of the semiconductor laser 1; lens holding means 10 for holding the objective lens 6; a sensor lens 8 and a sensor 9 arranged on the optical axis of light reflected by the PBS 3; a tracking error generation circuit 11 that receives an output from the sensor 9 to analyze it; and an actuator drive circuit 12 that receives an output from the tracking error generation circuit 11 to drive the lens holding means 10. The tracking error circuit 11 includes a polarity switch circuit and a tracking error detection circuit.

With this annealing apparatus, a light beam outputted by the semiconductor laser 1 is divided by the grating 2 into a non-diffracted light beam and two light beams that are ± first order diffracted beams. These light beams are transmitted through the PBS 3 and made substantially parallel by the collimator 4. The light beams are condensed on the magneto-optical disk 7 through the λ/4 plate 5 and the objective lens 6 as a main beam 31 and two subbeams 32 and 33. Then, the three beams 31, 32 and 33 reflected by the magneto-optical disk 7 are reflected by the PBS 3 and then condensed on the sensor 9 through the sensor lens 8.

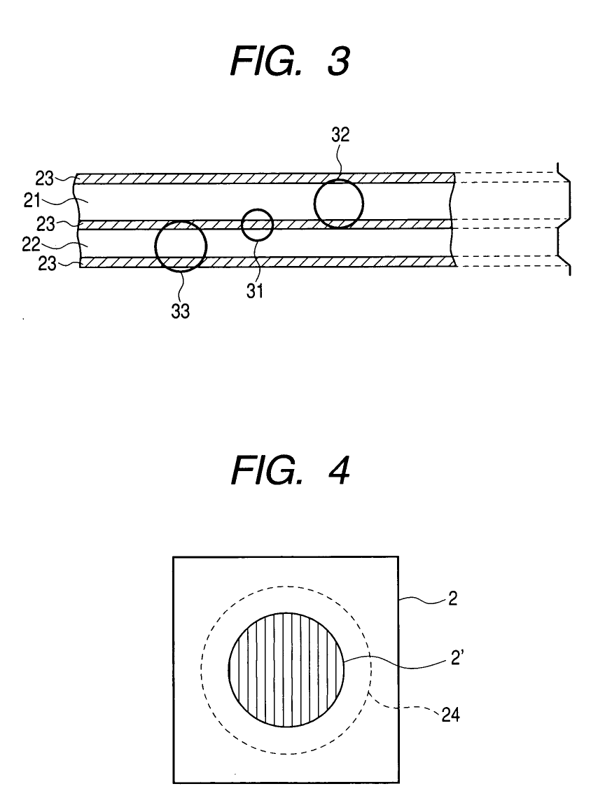

As shown in FIG. 3, of the beams condensed by the objective lens 6, the main beam 31 is condensed in the center and vicinity of the side wall 23 of the magneto-optical disk 7. One of the subbeam 32 and 33 (in the illustrated example, the subbeam 32) is condensed in the center and vicinity of the land 21, while the other (in the illustrated example, the subbeam 33) is condensed in the center and the vicinity of the groove 23. Thus, the side wall 23 and its vicinity are annealed by a fine spot (main beam 31) of a high intensity. However, since the ratio of the intensity of the main beam 31 to the intensity of the subbeam 32 is set at about 1:0.1 to 0.2 and the subbeam has a lower intensity, the land 21 and the groove 22 are not annealed even when irradiated with the subbeam 32 and 33.

To obtain such a fine spot (main beam 31) of a high intensity, the semiconductor laser 1 has a wavelength of 400 to 410 nm and the objective lens 6 has a numerical aperture (NA) of about 0.80 to 0.90. In the present embodiment, the semiconductor laser 1 has a wavelength of 410 nm and the objective lens 6 has an NA of 0.85. Then, the optimum value between 5 and 7 mW is determined for the intensity of the main beam 31 when the magneto-optical disk 7 rotates at a speed of 2 to 3 m/s. Then, the semiconductor laser 1 is set so that the intensity of the main beam 31 has this optimum value. In this connection, in the present embodiment, the objective lens 6 has a large NA (0.85), so that when light is incident on the magnetic layer 63 through the substrate 61, a mechanical variation in the substrate 61 may significantly vary the grade of the spot. To avoid this, light is incident from a side opposite to the substrate 61.

The magneto-optical disk 7 according to the present embodiment records and reproduces data on condition that the beam wavelength is 660 nm and that the objective lens has an NA of 0.60. In this case, typical push pull signals are unlikely to be obtained with a beam spot of wavelength of 410 nm obtained using an objective lens of NA of 0.85 as described previously. Thus, in order to obtain push pull signals, the subbeams 32 and 33 have an increased diameter as shown in FIG. 3. Specifically, the grating 2 such as the one shown in FIG. 4 is used to provide a spot corresponding to the subbeams 32 and 33 having a wavelength of 410 nm and obtained using an objective lens of NA of about 0.55 to 0.60. A circle 24 shown by the dotted line in FIG. 4 shows the diameter of a light beam on the grating 2 which corresponds to the incident pupil of the objective lens 6. The grate of the grating 2 is formed in an area 2′ smaller than the incident pupil. As a result, the diffracted light beam is thinner than the incident pupil at the incident pupil position of the objective lens 6. Thus, the main beam 31 thinned by the objective lens 6 of a small NA is condensed on the magneto-optical disk 7. In this case, the non-diffracted beam has its intensity reduced in its central portion. Accordingly, the main beam 31 is expected to provide what is called an “optical super-resolution” effect. Provided that the groove 22 is shaped to provide push pull signals even with a beam spot of wavelength of 410 nm obtained using an objective lens of NA of 0.85, the grate of the grating 2 may be provided in an area larger than the dotted circle (incident pupil) 24 as in the case with a conventional method.

On the other hand, the three beams 31, 32 and 33 reflected by the magneto-optical disk 7 are reflected again by the PBS 3 and then condensed on the sensor 9 through the sensor lens 8. In the tracking error generation circuit 11, the tracking error detection circuit detects a tracking error in an output signal from the sensor 9 to detect that one circle of the side wall 23 has been entirely annealed. Then, in response to the inverse inclination of a tracking error in the adjacent side wall 23, the polarity switch circuit switches the polarity of the tracking error. The actuator drive circuit 12 moves the objective lens holding means 10 so as to anneal the adjacent side wall 23 on the basis of the information from the tracking error generation circuit 11. That is, tracking servo is carried out.

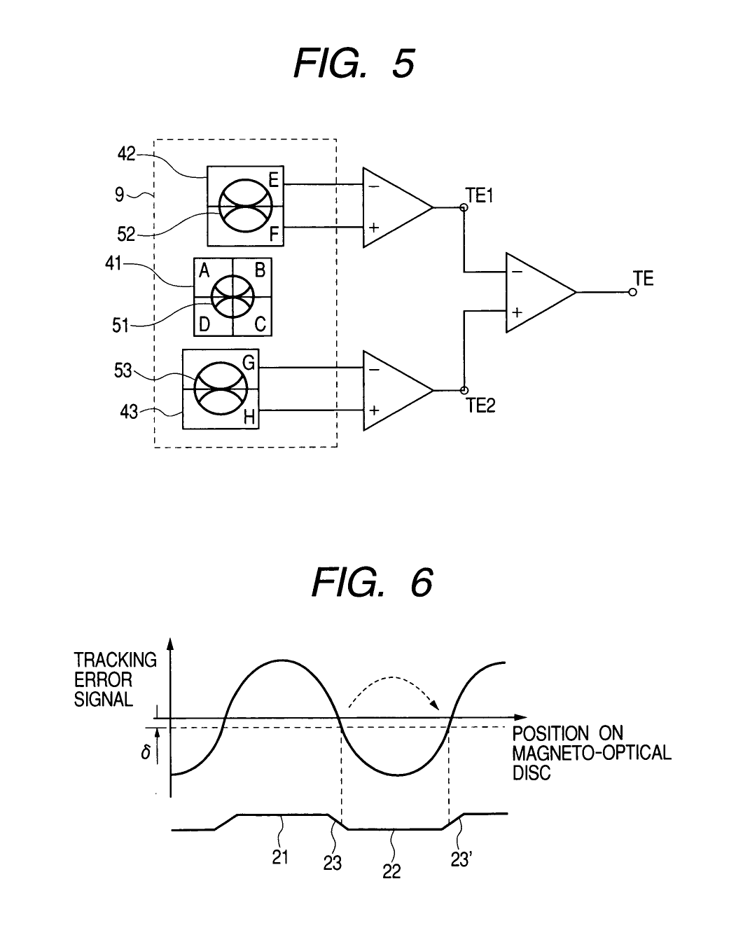

Detailed description will be given below as to the generation of a tracking error and the tracking servo. First with reference to FIG. 5, description will be given as to a method of generating a tracking error to track the main beam 31 on the side wall 23. The sensor 9 is composed of three divided sensors 41, 42 and 43. Spots 51, 52 and 53 are condensed on the divided sensors 41, 42 and 43, respectively, in association with the three beams 31, 32 and 33, respectively, on the magneto-optical disk 7. The divided sensor 41 provides a focus error signal on the basis of (A+C)−(B+D). On the other hand, the divided sensors 42 and 43 provide push pull tracking error signals on the basis of TE1=F−E and TE2=H−G. A well-known differential push pull method is applied to the subbeams 32 and 33, i.e., the spots 52 and 53. Then, a suppressed tracking error signal corresponding to a DC offset is obtained.

On the basis of this tracking error signal, stable tracking servo can be achieved when the side wall 23 is annealed. Then, an offset is provided as required. If the objective lens holding means 10 is moved to the adjacent side wall 23 as described above, after the polarity of the tracking error signal is switched, the tracking servo is carried out.

The tracking servo will be described. FIG. 6 shows the relationship between the land 21 and the groove 22 and the above-described tracking error signal. As shown in FIG. 6, when the objective lens holding means 10 is moved from the side wall 23 to the adjacent side wall 23′, the polarity is switched with an offset amount δ for detrack remaining unchanged. In this way, detrack to the groove 22 side can be always maintained. If the land 21 and the groove 22 have an equal width, this offset is in principle unnecessary. However, if the land 21 and the groove 22 have different widths, since the center of the side wall 23 is not the intermediate point between the center of the land 21 and the center of the groove 22, the spot must be slightly offset in order to track the center of the side wall 23. In the present embodiment, the land 21 is wider than the groove 22 as described later. Accordingly, the spot must be kept slightly detracked toward the groove 22.

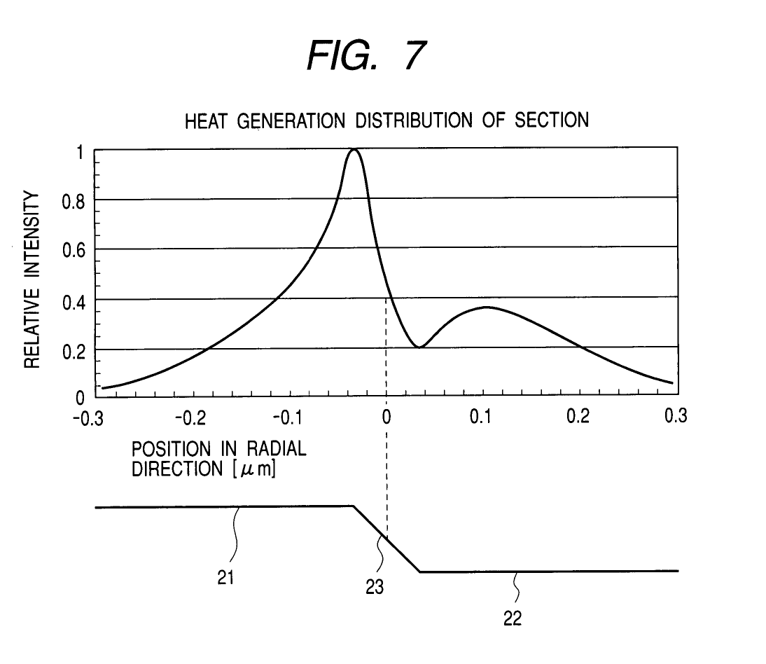

Now, with reference to the graphs and diagrams shown in FIGS. 7 to 10 as models, for the annealing of the side wall 23, description will be given as to the results of analysis of a light spot profile and the amount of light absorbed by a thin film, based on vector analysis, and the results of analysis of a temperature distribution using the results of the above analysis and based on a thermal diffusion equation.

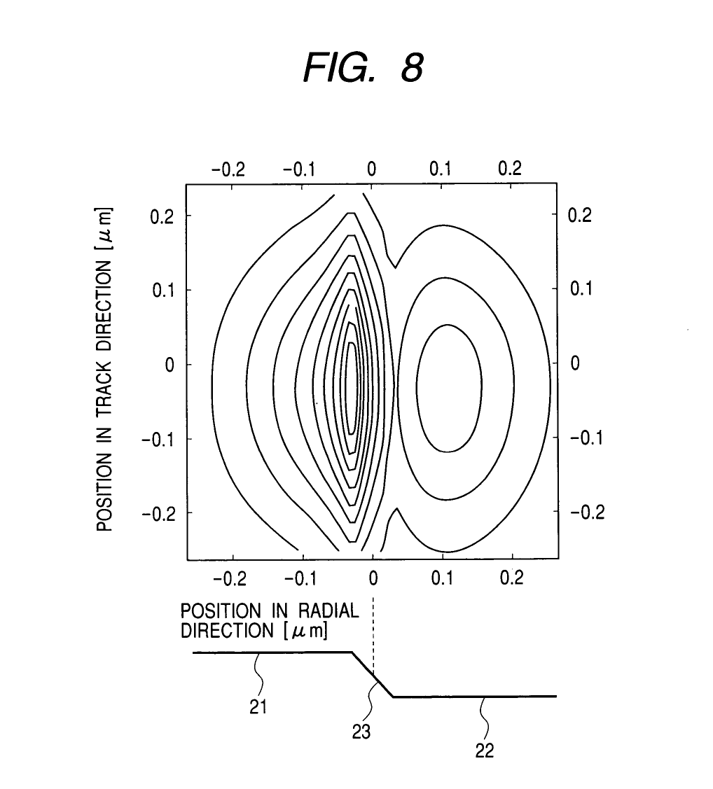

FIGS. 7 and 8 show a light absorption distribution observed when the center of the side wall 23 is irradiated with the spot 51 for annealing (main beam 31) at a line speed of 2.0 m/s. A position in a radial direction on the axis of abscissa of this graph is shown using the center of the side wall 23 as a reference (0). In this embodiment, the groove 22 has a depth of 60 nm, and the side wall 23 has an inclination of 45°. FIG. 7 is a light absorption distribution (heat generation distribution) in a cross section in the radial direction (the disc radius direction). FIG. 8 shows intensity contour lines for a planar light absorption distribution (heat generation distribution). In FIG. 8, a track direction corresponds to a spot movement direction and is shown using the position of the applied spot as the reference (0). FIGS. 7 and 8 indicate that light absorption has a peak near a land edge (the end of the land 21). That is, the light absorption distribution concentrates in the vicinity of the end of the convex land 21, which appears convex as viewed from a direction in which light is incident. This means the localization of electric fields in a fine structure, which is well known in the field of near field optics.

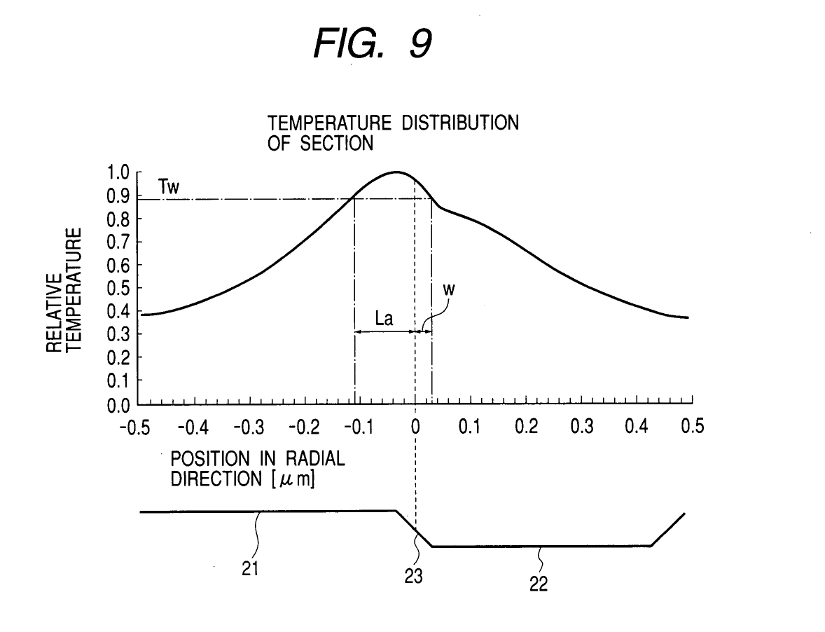

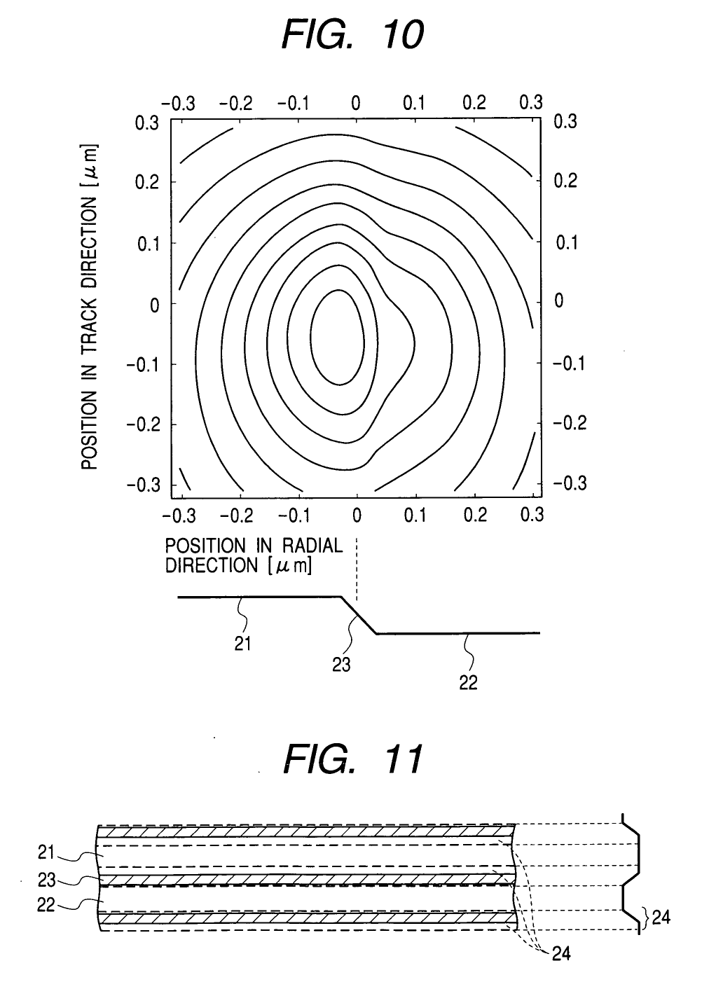

FIGS. 9 and 10 show corresponding temperature distributions at the time. FIG. 9 shows a temperature distribution in a cross section in the radial direction (the disc radius direction). FIG. 10 shows intensity contour lines of a planar temperature distribution. A peak of the temperature reflects the light absorption distribution and lies near the land edge. Even in a two-dimensional view, an area with a high temperature extends in the vicinity of the land edge. This indicates that the annealing temperature is sequentially reached starting with the area from the side wall 23 to the land 21.

As described above, the light absorption distribution has a peak near the land edge, and as a result, an area with high temperatures extends near the land edge. Accordingly, even if the spot is detracked during annealing, the process is not substantially affected.

In the present embodiment, the intensity of annealing irradiation light is adjusted and set so that the boundary between the groove 22 and the side wall 23 corresponds to a threshold for the annealing temperature. Specifically, in FIG. 9, the threshold for the annealing temperature is set to be a temperature Tw measured at a position (the end of the side wall 23 closer to the groove 22) offset from the center of the side wall 23 toward the groove 22 by a distance corresponding to the half w of the width of the side wall 23. Thus, in an area of the side wall 23 extending from the center of the side wall 23 toward the groove 22, only the area corresponding to the half w of the width of the side wall 23, i.e., the area between the center and end of the side wall 23 is annealed. However, in an area extending from the center of the side wall 23 over the land 21, since an area with high temperatures is larger than that on the groove 22 side as is apparent from the temperature distributions in FIGS. 9 and 10, an area with only a width La is annealed which is larger than the annealing area on the groove 22 side (which corresponds to the half w of the width of the side wall 23). That is, a part of the land 21 which is close to the side wall 23 is also annealed.

Thus, the land 21 must be relatively wide so that after the side wall 23 and its vicinity have been annealed using the center of the side wall 23 as a condensation center, as described above, the width of the track (recording and reproducing area) in the land 21 is almost equal to the width of the track (recording and reproducing area) in the groove 22. Desirably, the land 21 is wider than the groove 22 by a value (La-w). Thus, appropriate magnetic domain wall displacement reproduced signals can always be obtained by making the widths of the tracks uniform and without uselessly increasing the track pitch. In the present embodiment, the disc is irradiated with light from a side opposite to the substrate 61.

The magneto-optical disk 7 according to the present embodiment records and reproduces data using the land and groove system. The groove 22 suitably has a depth of about 10 to 80 nm, and the side wall 23 suitably has an inclination of about 15° to 75°. If the depth of the groove 22 is less than about 10 nm or is about 100 nm, push pull signals undergo an excessively low degree of modulation when the disc is irradiated with visible light beams. Consequently, tracking error signals cannot be correctly generated. On the other hand, if the groove 22 has a depth of more than 100 nm, the side wall 23 becomes excessively large provided that it has an inclination such that the substrate 61 can be easily formed. If the side wall 23 is excessively wide, the widths of the tracks (recording and reproducing areas according to the land and groove system) in the land 21 and groove 22 are correspondingly reduced after the side wall 23 is annealed. Consequently, the magnetic domain wall displacement type recording and reproduction cannot be successfully executed. On the other hand, if the side wall 23 has an inclination of less than 15°, it is likely that the side wall 23 becomes excessively large resulting in the previously described inconvenience. In contrast, if the side wall 23 has an inclination of more than 75°, then it is disadvantageously difficult to form the substrate 61. Consequently, the groove 22 suitably has a depth of about 10 to 80 nm, and the side wall 23 suitably has an inclination of about 15° to 75°. The groove 22 more suitably has a depth of about 20 to 60 nm, and the side wall 23 more suitably has an inclination of about 30° to 60°.

The magneto-optical disks 7 were actually analyzed, in which the groove 22 had a depth of 10 to 80 nm and in which the side wall 23 had an inclination of 15° to 75°. For the results of the analysis, Table 1 shows the (La-w) value, i.e., the difference in the width of the annealed area of the land 21 and the groove 22 in the case of the depth of the groove 22 being 20 nm, 40 nm and 60 nm, and the inclination of the side wall 23 being 30°, 45° and 60°. Further, Table 2 shows the width (2w) of the side wall 23 corresponding to Table 1.

TABLE 1
La-w

| Inclination | Depth of the groove 22 | | |
|---|---|---|---|
| of the side wall 23 | 20 nm | 40 nm | 60 nm |
| 30° | 50.3 nm | 63.8 nm | 72.8 nm |
| 45° | 46.3 nm | 61.9 nm | 78.1 nm |
| 60° | 42.2 nm | 54.5 nm | 64.9 nm |

TABLE 2
2w

| Inclination | Depth of the groove 22 | | |
|---|---|---|---|
| of the side wall 23 | 20 nm | 40 nm | 60 nm |
| 30° | 35 nm | 69 nm | 104 nm |
| 45° | 20 nm | 40 nm | 60 nm |
| 60° | 11 nm | 23 nm | 35 nm |

Tables 1 and 2 indicate that the ratio of the (La-w) value and the width 2w of the side wall 23 is about 0.7 to 3.8. That is, it is assumed that in the magneto-optical recording medium of the present invention for recording data using the land and groove system, when the groove 22 has a depth of about 20 to 60 nm and the side wall 23 has an inclination of about 30° to 60°, the side wall 23 and its vicinity are to be annealed by irradiations with light from the side opposite to the substrate 61, so that the land 21 becomes wider than the groove 22 by a value equal to about 0.7 to 3.8 times the width of the side wall 23 whereby, the width of the track (recording and reproducing area) in the land 21 after annealing is almost equal to the width of the track (recording and reproducing area) in the groove 22. Therefore, appropriate magnetic domain wall displacement reproduced signals can always be obtained without uselessly increasing the track pitch. When the groove 22 has a depth of about 10 to 80 nm and the side wall 23 has an inclination of about 15° to 75°, the land 21 is preferably wider than the groove 22 by a value equal to about 0.5 to 4 times the width of the side wall 23.

As described previously, the magneto-optical disk 7 according to the present embodiment records and reproduces data under the condition that the beam wavelength is 660 nm and that the objective lens has an NA of 0.60. The grooves 22 suitably have a pitch of about 1.0 to 1.2 microns if the land and groove system is used for recording and if the track pitch is desirably reduced. With a smaller pitch, even if the tracks can be magnetically separated from one another, critical problems may occur such as cross talk between the adjacent tracks. Thus, if the grooves 22 have a pitch of 1.0 to 1.2 microns, provided that the groove 22 has a depth of about 20 to 60 nm and the side wall 23 has an inclination of about 30° to 60°, the ratio of the width of the land 21 (half-value width) to the width of the groove 22 (half-value width) is about 1.07 to 1.17:1. Alternatively, provided that the groove 22 has a depth of about 10 to 80 nm and the side wall 23 has an inclination of about 15° to 75°, the ratio of the width of the land 21 (half-value width) to the width of the groove 22 (half-value width) is about 1.05 to 1.20:1.

The precondition for the above description is the anneal condition for the optical system according to the present embodiment. That is, the annealing light beams have a wavelength of 410 nm, and the objective lens 6 has an NA of 0.85. However, as shown in FIGS. 7 to 10, the design is based on a light absorption distribution concentrated in the vicinity of the edge of the land 21, which appears convex as viewed from the light incidence direction. Consequently, unless the annealing condition for the optical system deviates significantly from the annealing condition employed in the present embodiment, no marked variations result, and a favorable magneto-optical disk 7 is obtained using a substantially similar design.

Thus, the magneto-optical disk 7 according to the present embodiment is obtained, which is similar to the one shown in FIG. 1. The magneto-optical disk 7 is provided with an area 24 with a changed magnetism (magnetism changed area) which is located around the edge of the land 21 and which mainly constitutes an in-plane magnetized film, as shown in FIG. 11. By way of example, the groove was formed to have a depth of 60 nm and the side wall 23 was formed to have an inclination of 45°. Thus, (La-w) was set at about 0.08 micron, and w was set at about 0.06 micron. Further, the grooves 22 were formed to have a pitch of 1.08 microns, the land 21 was formed to have a width (half-value width) of 0.58 micron, and the groove 22 was formed to have a width (half-value width) of 0.50 micron. Then, after annealing, the track (recording and reproducing area) had a width of about 0.44 micron, and the tracks in the land 21 and groove 22 had almost the same width. Further, the ratio of the width of the land 21 (half-value width) to the width of the groove 22 (half-value width) was about 1.16 to 1. Thus, a magnetic domain wall displacement type magneto-optical disk was obtained which had a track width of 0.44 micron and a small track pitch of 0.54 micron and had relatively shallow grooves 22.

What is claimed is:

1. A magnetic domain wall displacement type magneto-optical recording medium comprising:
a substrate in which a land and a groove are formed; and
a magnetic layer formed on the substrate;
wherein the magnetic layer on a side wall present between the land and the groove, and in a vicinity of the side wall is annealed, and a width of the land is larger than a width of the groove.

2. The magnetic domain wall displacement type magneto-optical recording medium according to claim 1, wherein the magnetic layer includes at least a magnetic domain wall displacement layer, a switching layer, and a record retaining layer.

3. The magnetic domain wall displacement type magneto-optical recording medium according to claim 1, wherein the width of the land is larger than the width of the groove by 0.5 to 4 times a width of the side wall.

4. The magnetic domain wall displacement type magneto-optical recording medium according to claim 1, wherein the grooves have a period of 1.0 to 1.2 microns, and a ratio of the width of the land to the width of the groove is 1.05 to 1.20.

5. The magnetic domain wall displacement type magneto-optical recording medium according to claim 1, wherein the magnetic layer has physical properties changed in the annealed area.
